(19) United States
(12) Patent Application Publication
(10) Pub. No.: US 2004/0187634 A1
(43) Pub. Date: Sep. 30, 2004

(54) Spring-based crankshaft coupling structure for engine

(76) Inventor: Siegfried Meyer, Oettingen (DE)

Correspondence Address: ROSENBERG, KLEIN & LEE, 3458 ELLICOTT CENTER DRIVE-SUITE 101, ELLICOTT CITY, MD, 21043, US

(21) Appl. No.: 10/772,460

(22) Filed: Feb. 6, 2004

Related U.S. Application Data
(60) Provisional application No. 60/457,300, filed on Mar. 26, 2003.

(51) Int. Cl. G05G 1/00

(52) U.S. Cl. 74/581

(57) ABSTRACT

A spring-based crankshaft coupling structure used in an engine and coupled between a piston and a crankshaft to enhance the output torque of the engine is disclosed to include a first coupling member pivoted to the piston, the first coupling member having a downwardly extended receiving open chamber defined in a downwardly extended hollow body thereof and an inner tube suspended in the downwardly extended receiving open chamber, a second coupling member pivoted to the crankshaft, the second coupling member having an upwardly extended hollow body axially movably sleeved onto the inner tube in the hollow body of the first coupling member, and an axially compressible spring member mounted in the inner tube inside the first coupling member and coupled between the first coupling member and the second coupling member.

### BACKGROUND OF THE INVENTION

1. Field of the invention

The present invention relates to an internal combustion end and, more specifically, to a spring-based crankshaft coupling structure for use in an engine to connect a crankshaft to a piston and to increase the output torque of the engine.

2. Description of the Related Art

In a typical internal combustion engine, of the type found in most vehicles today, a plurality of pistons are respectively movably mounted in a plurality of cylinders formed in an engine block. Each of the pistons has one end connected with a piston rod and the other end coupled to a crankshaft. When spark plugs in the engine block fired to ignite fuel mixture, the pistons are driven downward to turn the crankshaft, which ultimately drives the entire vehicle. At present, in a typical engine, connecting rods are used and connected with the respective first end to the corresponding piston and the respective second end to the corresponding crankshaft. The connecting points between the two ends of each connecting rod and the corresponding piston and corresponding crankshaft are disposed at the ends of the longitudinal center axis of the respective connecting rod. By means of the coupling of the connecting rod between the corresponding piston and the corresponding crankshaft, reciprocating motion of the piston causes the corresponding crankshaft to rotate.

Presently, researchers have reported many studies to enhance the output torque by extending the moving distance of the connecting rods between the pistons and the crankshafts.

### SUMMARY OF THE INVENTION

The present invention has been accomplished under the circumstances in view. It is one object of the present invention to provide a crankshaft coupling structure for engine, which greatly enhances the output torque of the engine.

It is another object of the present invention to provide a crankshaft coupling structure for use engine, which saves fuel consumption of the engine.

It is still another object of the present invention to provide a crankshaft coupling structure for engine, which improves the performance of the engine, resulting in reduced amount of solid matter in exhaust gas of the engine.

To achieve these and other objects of the present invention, the crankshaft coupling structure is installed in an engine and coupled between a piston and a crankshaft, comprising a first coupling member pivoted to the piston, the first coupling member comprising a downwardly extended receiving open chamber defined in a downwardly extended hollow body thereof and an inner tube suspended in the downwardly extended receiving open chamber inside the downwardly extended hollow body; a second coupling member pivoted to the crankshaft, the second coupling member comprising an upwardly extended hollow body inserted into the downwardly extended receiving open chamber and axially movably sleeved onto the inner tube, and an upwardly extended receiving open chamber defined in the upwardly extended hollow body thereof and adapted to receive the inner tube and an axially compressible spring member mounted in the inner tube inside the first coupling member and coupled between the first coupling member and the second coupling member.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 is a plain view showing the spring-based crankshaft coupling structure coupled between a piston and a crankshaft according to the present invention.

FIG. 2 is a sectional view, showing the detailed structure of the spring-based crankshaft coupling structure coupled between a piston and a crankshaft according to the present invention.

FIG. 3 is a schematic drawing showing the action of the spring-based crankshaft coupling structure according to the present invention . . .

FIGS. 3A˜3D are schematic drawings showing one moving cycle of the spring-based crankshaft coupling structure with the piston from the top dead center to the bottom dead center and then from the bottom dead center back to the top dead center according to the present invention.

### DETAILED DESCRIPTION OF THE PREFERRED EMBODIMENT

Reference will now be made in detail to the preferred embodiment of the present invention, examples of which are illustrated in the accompanying drawings. Wherever possible, the same reference numbers are used in the drawings and the description to refer to the same or like parts.

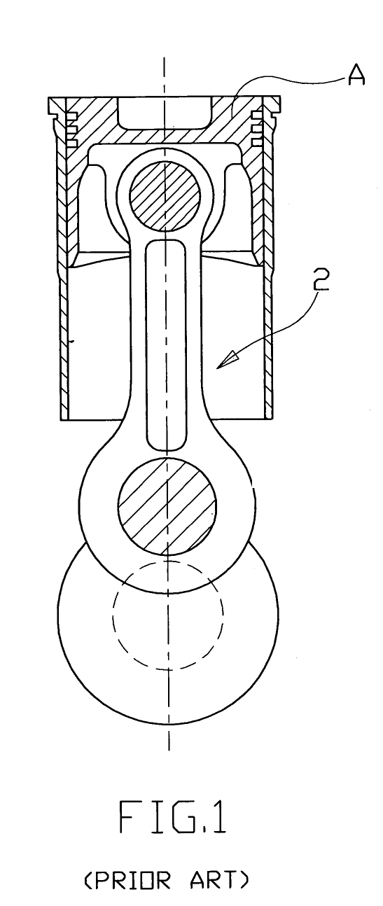

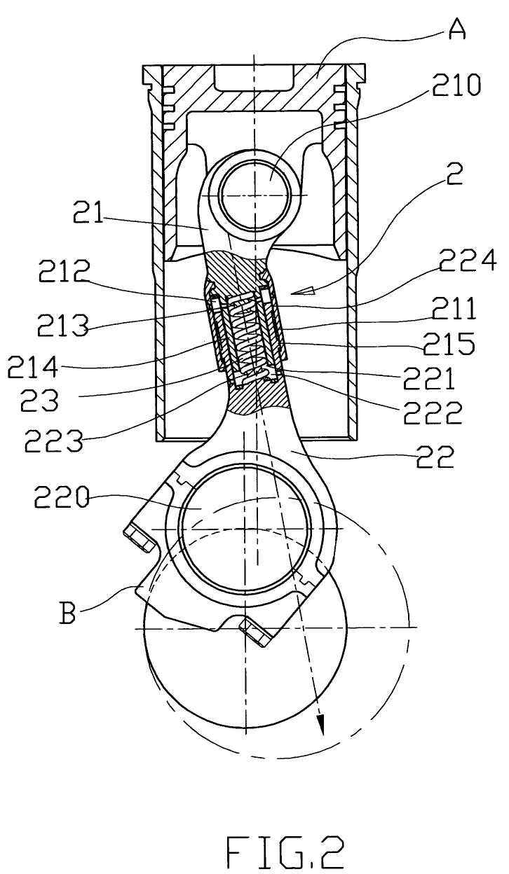

Referring to FIGS. 1˜3, a spring-based crankshaft coupling structure 2 is shown comprised of a first coupling member 21, a second coupling member 22, and an axially compressible spring member 23.

The first coupling member 21 is pivoted to a piston A by a pivot pin 210, comprising a downwardly extended hollow body 211, a receiving open chamber 212 defined in the hollow body 211, an inner tube 213 suspended in the receiving open chamber 212, and a stem 214 coaxially suspended in the inner tube 213.

The second coupling member 22 is pivoted to a crankshaft B by a pivot pin 220, comprising an upwardly extended hollow body 221, which is inserted into the receiving open chamber 212 inside the hollow body 211 and axially movably sleeved onto the inner tube 213, a receiving open chamber 222 defined in the hollow body 221 and adapted to receive the inner tube 213, and a stem 223 suspended in the receiving open chamber 222 corresponding to the stem 214 in the first coupling member 21.

The spring member 23 according to the present invention is a compression spring mounted inside the inner tube 213 and connected between the stem 214 of the first coupling member 21 and the stem 223 of the second coupling member 22. The spring member 23 imparts an outward pressure to the second coupling member 22 against the first coupling member 21, i.e., the spring member 23 forces the second coupling member 22 away from the first coupling member 21.

Further, in order to prevent disconnection of the second coupling member 22 from the first coupling member 21, a stop structure is provided. According to this embodiment, the stop structure comprises a first annular stop flange 215 radially inwardly protruded from the bottom end of the Hollow body 211 of the first coupling member 21, and a second annular stop flange 224 radially outwardly protruded from the top end of the hollow body 221 of the second coupling member 22. The outer diameter of the second annular stop flange 224 is approximately equal to the inner diameter of the hollow body 211 of the first coupling member 21 so that the second annular stop flange 224 can be moved with the second coupling member 22 smoothly and stably in the receiving open chamber 212 along the inner tube 213. The inner diameter of the first annular stop flange 215 is approximately equal to the outer diameter of the hollow body 221 of the second coupling member 22. When extending the second coupling member 22 out of the first coupling member 21, the second annular stop flange 224 will be stopped at the first annular stop flange 215, preventing disengagement of the second coupling member 22 from the first coupling member 21.

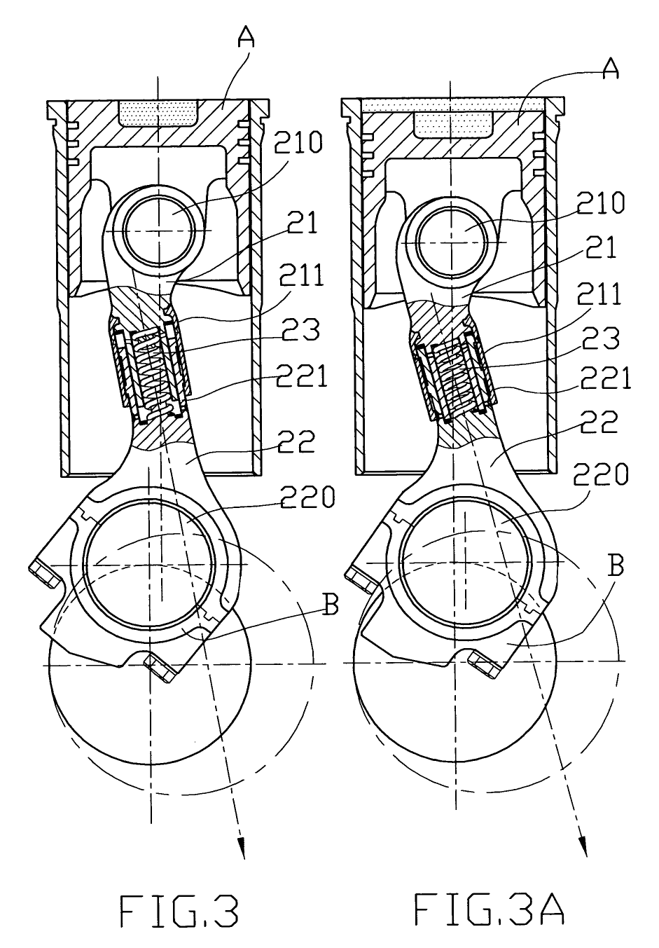

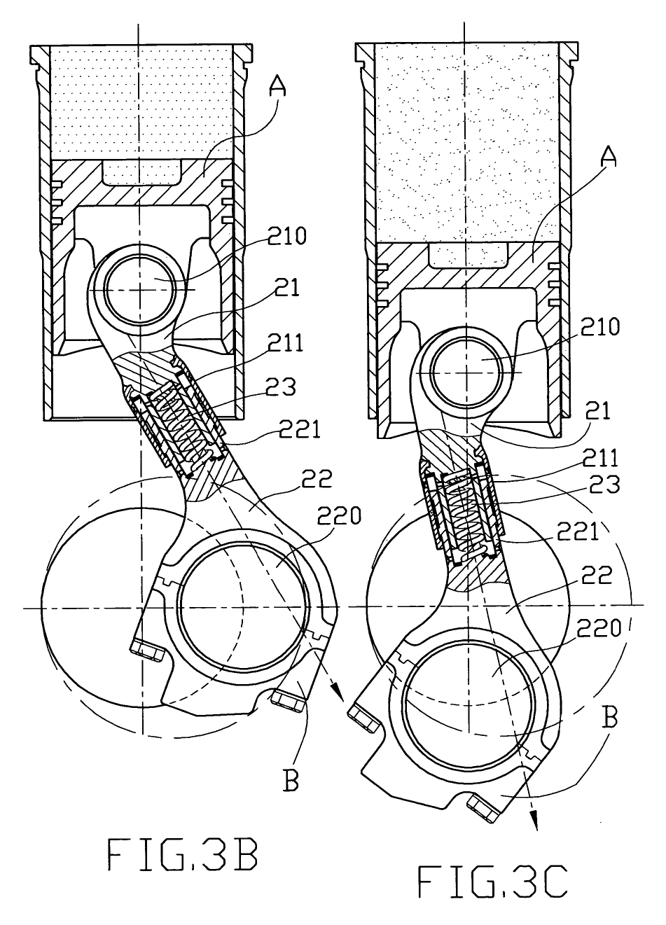

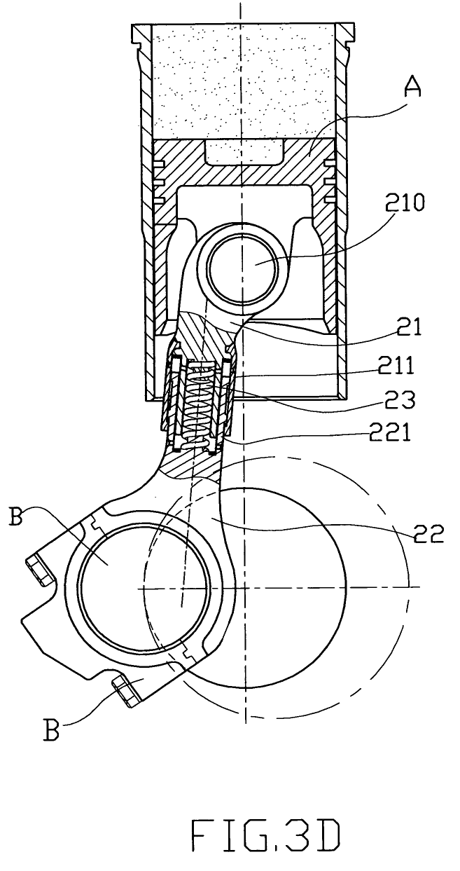

Referring to FIGS. 3A˜3D, when the spring-based crankshaft coupling structure 2 moved with the piston A to the top dead center in the combustion engine, the second coupling member 22 is lifted to compress the spring member 23. During the down stroke of the piston A from the top dead center in the combustion engine toward the bottom dead center, the spring member 23 is released to force the second coupling member 22 outwards relative to the first coupling member 21. Therefore, the invention extends the stroke of the spring-based crankshaft coupling structure 2, enhancing the output torque of the engine . . .

As indicated above, the spring-based crankshaft coupling structure of the present invention uses two coupling members sliding one with the other to couple the crankshaft to the piston and an axially compressible spring member to join the coupling members. This arrangement greatly enhances the output torque of the engine. Because the invention greatly improves the performance of the engine, it makes the engine to save fuel consumption and to reduce waste gas production.

A prototype of spring-based crankshaft coupling structure for engine has been constructed with the features of FIGS. 1˜3. The spring-based crankshaft coupling structure for engine functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A spring-based crankshaft coupling structure used in an engine and coupled between a piston and a crankshaft to enhance the output torque of the engine, comprising:
a first coupling member pivoted to said piston, said first coupling member comprising a downwardly extended receiving open chamber defined in a downwardly extended hollow body thereof and an inner tube suspended in said downwardly extended receiving open chamber inside said downwardly extended hollow body;
a second coupling member pivoted to said crankshaft, said second coupling member comprising an upwardly extended hollow body inserted into the downwardly extended receiving open chamber and axially movably sleeved onto said inner tube, and an upwardly extended receiving open chamber defined in said upwardly extended hollow body thereof and adapted to receive said inner tube and
an axially compressible spring member mounted in said inner tube inside said first coupling member and coupled between said first coupling member and said second coupling member.

2. The spring-based crankshaft coupling structure as claimed in claim 1, wherein said first coupling member comprises a stem coaxially suspended inside said inner tube; said second coupling member comprises a stem suspended in said upwardly extended receiving open chamber and aimed at the stem of said first coupling member; said axially compressible spring member has two ends respectively fastened to the stem inside said first coupling member and the stem inside said second coupling member.

3. The spring-based crankshaft coupling structure as claimed in claim 2, further comprising stop means adapted to limit the distance of axial movement of said second coupling member relative to said first coupling member.

4. The spring-based crankshaft coupling structure as claimed in claim 3, wherein said stop means comprises a first annular stop flange radially inwardly protruded from a bottom end of the hollow body of said first coupling member and disposed in contact with the periphery of the hollow body of said second coupling member, and a second annular stop flange radially outwardly protruded from a top end of the hollow body of said second coupling member and disposed in contact with an inside wall of the hollow body of said first coupling member.

5. The spring-based crankshaft coupling structure as claimed in claim 1, wherein said axially compressible spring member is a compression spring.
